(19) United States
(12) Patent Application Publication
(10) Pub. No.: US 2005/0289557 A1
(43) Pub. Date: Dec. 29, 2005

(54) Data transport apparatus, systems, and methods

(76) Inventor: Alexander V. Supalov, Erftstadt (DE)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/881,324

(22) Filed: Jun. 29, 2004

(51) Int. Cl. G06F 9/46

(52) U.S. Cl. 719/317

(57) ABSTRACT

An apparatus and a system, as well as a method and an article, may operate to receive event notifications at a message passing interface from a plurality of consumer notification modules after activating an operating system wait proxy agent. The consumer notification modules may be included in a direct access provider library coupled to a plurality of fabrics.

### TECHNICAL FIELD

Various embodiments described herein relate to the field of data processing, including apparatus, systems, and methods that operate to transport data from one location to another.

### BACKGROUND INFORMATION

Program objects and processes may communicate via messages. For example, message passing can be used on certain classes of parallel-processing machines, including those with shared and/or distributed memory. Thus, programmers may use a message passing interface (MPI) to register send and receive requests with a data transport medium (e.g., an underlying fabric layer), such as a memory or a network, to implement a forward, or request chain. The MPI may also be used to receive responses, implementing a backward, or notification chain.

Due to the existence of progress and ordering rules included in some MPI standards, a multiple-fabric MPI configuration may utilize implementation-dependent mechanisms, creating increased complexity and cost. For more information on standards applicable to messaging, please refer to MPI: A Message-Passing Interface Standard, The Message Passing Interface Forum, Ver. 1.1, June, 1995, and later versions.

### BRIEF DESCRIPTION OF THE DRAWINGS

FIG. 1 is a block diagram of an apparatus and a system according to various embodiments of the invention;

FIG. 2 is a flow chart illustrating several methods according to various embodiments of the invention; and

FIG. 3 is a block diagram of an article according to various embodiments of the invention.

### DETAILED DESCRIPTION

For the purposes of this document, a “device access provider library” (DAPL) is any module or collection of modules that operate to provide a set of transport-independent, platform-independent Application Programming Interfaces (APIs) that exploit the RDMA (remote direct memory access) capabilities of next-generation interconnect technologies according to the principles set forth in the documents kDAPL: Kernel Direct Access Programming Library, Ver. 1.1, 2003, and later versions, and uDAPL: User Direct Access Programming Library, Ver. 1.1, 2003, and later versions (collectively, the “DAPL standards”).

The term “fabric” may include any type of data storage or transport medium, such as a network, a memory, a disk drive, etc.

An “operating system wait proxy agent” (OSWPA) may include any module that may be triggered by a consumer notification object (CNO). Additional methods may exist for waiting on some operating system wait proxy agents. Some operating system wait proxy agents may trigger external operating system-specific semaphores, message queues, or file descriptors. In some embodiments, an OSWPA may be included in and/or combined with a DAPL to provide improved access to multiple fabrics by way of an MPI.

The polymorphism of a DAPL interface enables automatic device selection based upon end points (EPs) bound to fabric-specific interface adaptors (IAs). Thus, a forward (request) chain can be established from the application, through the MPI, to various EPs, IAs, and the respective fabrics.

In the backward (notification) chain, events (send and receive completions, etc.) may be generated by the IAs and passed through the EPs to attending event dispatchers (EVDs). EVDs from one IA can be made to pass events to a Consumer Notification Object (CNO), which may in turn activate an OSWPA that can be shared between all CNOs, and hence, all IAs involved. This process may also be applied to events produced by Public Service Points (PSP) and Reserved Service Points (RSP) that are used for advertising and establishing connections.

The CNOs can be polled, if desired, or a timed waiting period can be employed, for example. Thus, the MPI (e.g., an MPI device layer) may operate to ensure that every CNO that represents a constituent fabric is attended on some periodic basis. In this manner, in some embodiments, all notifications can be harvested via the OSPWA, or via individual CNOs. Therefore, the DAPL interface (including the OSWPA) can be used to create an MPI multifabric implementation as well as unifabric implementation. For more information with respect to how CNOs, EPs, EVDs, IAs, PSPs, and RSPs operate, please refer to the DAPL standards.

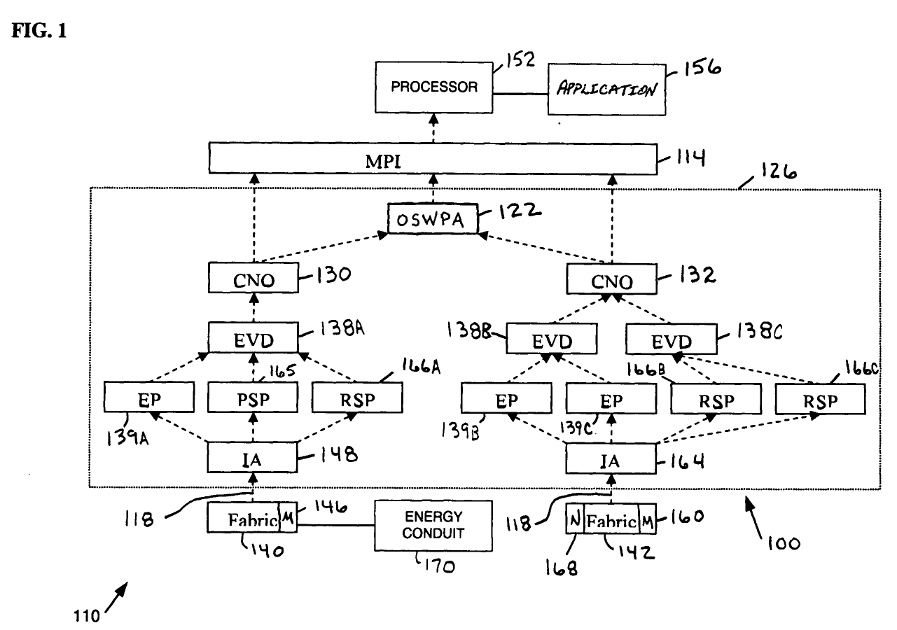

FIG. 1 is a block diagram of an apparatus 100 and a system 110 according to various embodiments of the invention, each of which may operate in the manner described. In some embodiments, the apparatus 100 may include an MPI module 114 to receive data 118 from an OSWPA module 122 included in a DAPL 126. In some embodiments, the DAPL 126 may include a plurality of CNO modules 130, 132 coupled to the OSWPA module 122, as well as a plurality of EVD modules 138A, 138B, 138C coupled to one or more of the CNO modules 130, 132. Within the DAPL 126, one or more EPs 139A, 139B, and/or 139C may be coupled to the EVD modules 138A, 138B, 138C.

The DAPL 126, in turn, may be coupled to one or more fabrics 140, 142. In some embodiments, the fabric 140 may comprise a memory, such as a cache. Another fabric 142 may comprise a hard disk drive located in the same computing device as the fabric 140. In other embodiments, the fabric 140 may comprise a first portion of a memory, and the fabric 142 may comprise a second portion of the same memory. In still other embodiments, the fabric 140 may comprise a non-volatile memory, and the fabric 142 may comprise a network that is located physically outside of the computing device housing the fabric 140.

It should be noted that the plurality of fabrics 140, 142 need not include a microprocessor bus. In fact, the methods disclosed herein provide mechanisms for bypassing the use of a bus to transport data from one fabric to another, even within the same computing device. Thus, any number of embodiments having unifabric and multi-fabric configurations may be realized.

For example, in some embodiments, an apparatus 100 may include a first memory 146 in a first fabric 140 coupled to a first IA 148 included in the DAPL 126, to communicate with the MPI module 114 coupled to a processor 152, perhaps executing an application 156. The apparatus 100 may also include a second memory 160 in a second fabric 142 coupled to a second IA 164 included in the DAPL 126, also used to communicate with the MPI 114 and the processor 152. Within the DAPL 126, the IAs 148, 164 may be coupled to the EVDs 138A, 138B, 138C via EPs 139A, 139B, PSPs 165, and/or RSPs 166A, 166B, 166C. Many other embodiments may be realized.

For example, an apparatus 100 may include an OSWPA module 122 as part of a DAPL 126 to couple to an MPI module 114. The OSWPA module 122 may be used to receive data 118 from a plurality of fabrics 140, 142 coupled to the DAPL 126.

In some embodiments, the apparatus 100 may include a DAPL 126 having a plurality of CNO modules 130, 132 coupled to the OSWPA 122. In some embodiments, all notifications provided by the CNO modules 130, 132 may be communicated to the OSWPA 122. As noted previously, the plurality of fabrics 140, 142 may include a network 168, and/or a memory 146 coupled a processor 152 capable of communicating with the MPI module 114.

The apparatus 100 may be suitable for use in many products, including those designed to conform to an Institute of Electrical and Electronics Engineers (IEEE) 802.xx protocol standard, an IEEE 1596 interface standard (Scalable Coherent Interface, “SCI”), a VME Bus International Trade association (“VITA”) Standards Organization VITA 26-199x specification (“Myrinet”), an InfiniBand Trade Association (IBTA) InfiniBand architecture specification, a Quadrics Ltd. QsNet/QsNet II architecture, and/or derivatives of these standards and/or specifications. Thus, for example, the data 118 may be formatted according to a number of standards and/or specifications, prior to entering the fabrics 140, 142, or after exiting the fabrics 140, 142.

Such standards include, for example, but are not limited to, an IEEE 802.3 standard, an IEEE 802.3AE standard, an IEEE 1596 standard, a VITA 26-199x specification, an InfiniBand Architecture Release 1.1 specification, a QsNet/QsNet II architecture description, an IEEE 802.11 standard, an IEEE 802.16 standard, and an IEEE 802.20 standard. For more information on the various IEEE 802.3 standards, please refer to IEEE STD 802.3-2002, “Information Technology—Telecommunications and Information Exchange Between Systems—Local and Metropolitan Area Network—Specific Requirements—Part 3: Carrier Sense Multiple Access with Collision Detection (CSMA/CD) Access Method and Physical Layer Specifications: 2002.” For more information on the IEEE 802.3AE standard, please refer to IEEE STD 802.3AE-2002, “Information Technology—Telecommunications and Information Exchange Between Systems—Local and Metropolitan Area Network—Specific Requirements—Part 3: Carrier Sense Multiple Access with Collision Detection (CSMA/CD) Access Method and Physical Layer Specifications-Amendment: Media Access Control (MAC) Parameters, Physical Layers, and Management Parameters for 10 Gb/s Operation: 2002.” For more information on the IEEE 1596 standard, please refer to IEEE STD 1596.5-1993, “Standard for Shared-Data Formats Optimized for Scalable Coherent Interface (SCI) Processors: 1993.” For more information on the Myrinet specification, please refer to VMEbus International Trade Association (“VITA”) Draft Specification VITA 26-199x, “Myrinet-on-VME—Protocol Specification—Draft 1.1: 1998.” For more information on InfiniBand architecture, please refer to InfiniBand Trade Association (“ITA”) specification “InfiniBand Architecture Specification Release 1.1: 2002.” For more information on QsNet/QsNet II, please refer to the Quadrics Ltd. website at www.quadrics.com.

For more information on the various IEEE 802.11 standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related versions. For more information regarding IEEE 802.16 standards, please refer to “IEEE Standard for Local and Metropolitan Area Networks—Part 16: Air Interface for Fixed Broadband Wireless Access Systems, IEEE 802.16-2001”, as well as related amendments and standards, including “Medium Access Control Modifications and Additional Physical Layer Specifications for 2-11 GHz, IEEE 802.16a-2003”. For more information regarding IEEE 802.20 standards, please refer to “IEEE Standard for Local and Metropolitan Area Networks—Part 20: Standard Air Interface for Mobile Broadband Wireless Access Systems Supporting Vehicular Mobility—Physical and Media Access Control Layer Specification, IEEE 802.20 PD-02, 2002”, as well as related amendments and documents, including “Mobile Broadband Wireless Access Systems Access Systems “Five Criteria” Vehicular Mobility, IEEE 802.20 PD-03, 2002.

Many other embodiments may be realized. For example, a system 110 may include an apparatus similar to or identical to the apparatus 100, previously described. The system 110 may also include an energy conduit 170, such as an antenna, including patch, omnidirectional, beam, monopole, dipole, and rhombic antennas, among others, to receive the data 118 from a network 168 included in the plurality of fabrics 140, 142. As noted previously, the data 118 may be formatted according to any number of standards, including, for example, an IEEE 802.3 standard, an IEEE 802.3AE standard, an IEEE 1596 standard, a VITA 26-199x specification, an InfiniBand Architecture Release 1.1 specification, a Quadrics QsNet/QsNet II description, an IEEE 802.11 standard, an IEEE 802.16 standard, an IEEE 802.20 standard, and/or derivatives of these standards and/or specifications.

In some embodiments, the DAPL 126 may include one or more IAs 148, 164 coupled (directly or indirectly) to the energy conduit 170, such as an omnidirectional antenna. The DAPL 126 may also include the OSWPA 122 and a plurality of CNO modules 130, 132 coupled to the OSWPA 122. The energy conduit 170, perhaps including an omnidirectional antenna, may be included in a multiple-input, multiple-output (MIMO) communications system.

The apparatus 100, system 110, MPI module 114, data 118, OSWPA module 122, DAPL 126, CNO modules 130, 132, EVD modules 138A, 138B, 138C, EPs 139A, 139B, fabrics 140, 142, memories 146, 160, IAs 148, 164, processor 152, application 156, PSPs 165, RSPs RSPs 166A, 166B, 166C, network 168, and energy conduit 170 may all be characterized as “modules” herein. Such modules may include hardware circuitry, and/or a processor and/or memory circuits, software program modules and objects, and/or firmware, and combinations thereof, as desired by the architect of the apparatus 100 and systems 110, and as appropriate for particular implementations of various embodiments. Such modules may be included in a system operation simulation package, such as a software electrical signal simulation package, a power usage and distribution simulation package, a capacitance-inductance simulation package, a power/heat dissipation simulation package, a MIMO signal transmission-reception simulation package, and/or a combination of software and hardware used to simulate the operation of various potential embodiments.

It should also be understood that the apparatus and systems of various embodiments can be used in applications other than as an MPI implementation. The principles disclosed may be used in other software and hardware products, such as file input-output subsystems, database engines, etc. The illustrations of apparatus 100 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others. Some embodiments include a number of methods.

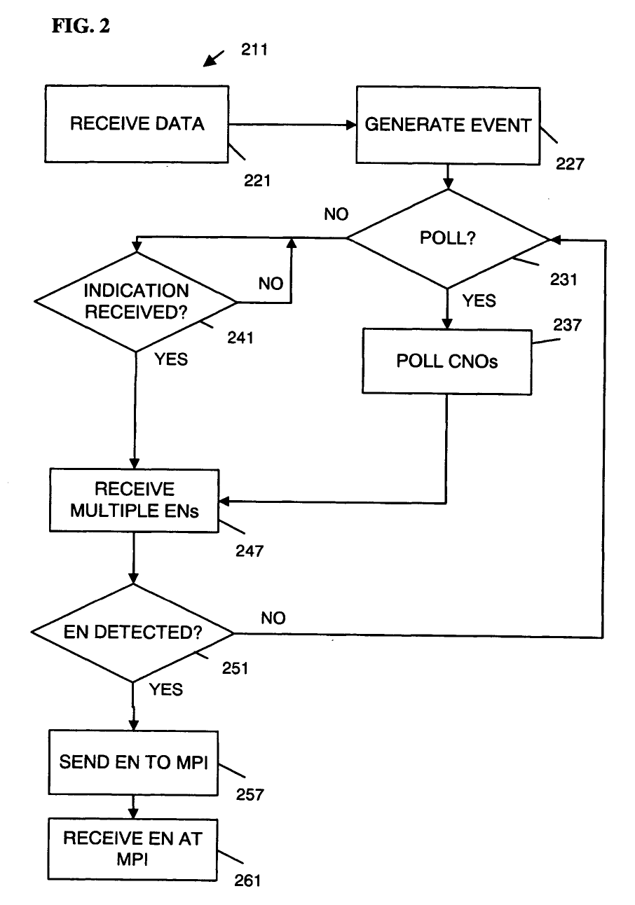

For example, FIG. 2 is a flow chart illustrating several methods according to various embodiments of the invention. A method 211 may (optionally) begin at block 221 with receiving data at an IA included in a DAPL from one of a plurality of fabrics. As noted previously, the data may be formatted according to one of an IEEE 802.3 standard, an IEEE 802.3AE standard, an IEEE 1596 standard, a VITA 26-199x specification, an InfiniBand Architecture Release 1.1 specification, a Quadrics QsNet/QsNet II description, an IEEE 802.11 standard, an IEEE 802.16 standard, an IEEE 802.20 standard, and/or derivatives of these standards and/or specifications, among others.

The method 211 may continue with generating an event at the IA at block 227. As has been previously noted, polling the CNO modules to determine the existence of events is possible, as well as waiting for an indication of the event (e.g., an event notification).

If polling is desired, as determined at block 231, the method 211 may continue at block 237 with polling one or more of the CNO modules to retrieve an event notification. If polling is not used to retrieve event notifications, as determined at block 231, then the method 211 may continue with waiting, by the OSWPA, for an event notification to be provided by one of the CNO modules at block 241. This may occur, for example, by triggering one of the CNO modules to provide the event notification by receiving an indication of an event (associated with the event notification) from one of the EVD modules. If no event notification is received at block 241, the OSWPA may continue to wait at block 241 until a selected timeout period occurs.

The method 211 may proceed from block 241 (after receiving an indication of an event notification, or the notification itself) to block 247, perhaps receiving a multiplicity of event notifications at the OSWPA from one or more of the CNO modules. If one or more event notifications are detected at the OSWPA, as determined at block 251, then the method 211 may proceed to block 257. Events may be detected, for example, by activating the OSWPA using one of the CNO modules, responsive to receiving an indication of an event notification (or the notification itself). If no events are detected at block 251, then the method may proceed to block 231.

The method 211 may include sending, by the OSWPA, an event notification to an MPI at block 257. The method 211 may then proceed with receiving the event notification at the MPI from one or more of the CNO modules (coupled to the OSWPA) after the OSWPA is activated by the CNO modules at block 261.

It should be noted that the methods described herein do not have to be executed in the order described, or in any particular order. Moreover, various activities described with respect to the methods identified herein can be executed in iterative, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-oriented format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

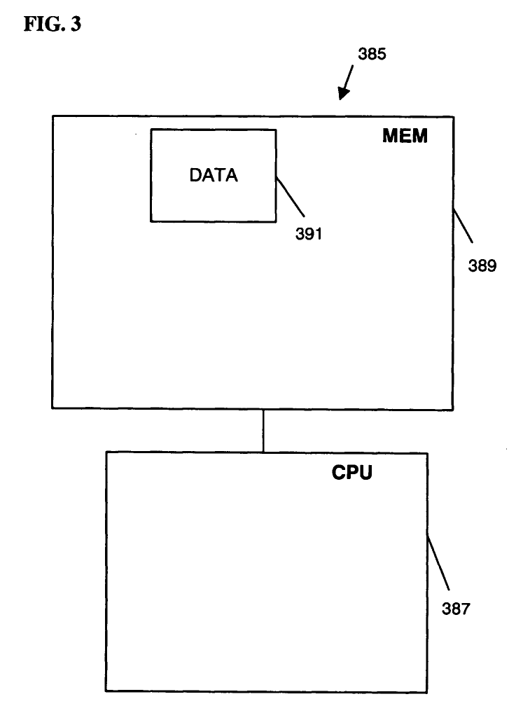

For example, FIG. 3 is a block diagram of an article 385 according to various embodiments of the invention, such as a computer, a memory system, a magnetic or optical disk, some other storage device, and/or any type of electronic device or system. The article 385 may include a processor 387 coupled to a machine-accessible medium such as a memory 389 (e.g., a memory including an electrical, optical, or electromagnetic conductor) having associated information 391 (e.g., computer program instructions and/or data), which, when accessed, results in a machine (e.g., the processor 387) performing such actions as receiving an event notification at an MPI from one of a plurality of CNO modules coupled to an OSWPA after the OSWPA is activated by the one of the CNO modules (included in a DAPL coupled to a plurality of fabrics).

Other activities may include receiving data at an IA included in a DAPL from one or more of a plurality of fabrics, wherein the data is formatted according to various standards, as mentioned previously; as well as receiving a multiplicity of event notifications at the OSWPA from the CNO modules. In some embodiments, the plurality of fabrics need not include a microprocessor bus.

Further activities may include generating an event at an IA included in the DAPL, and providing an indication of the event to the one of a plurality of CNO modules by an EVD module. The OSWPA may be activated by one of the CNO modules responsive to the indication.

Although the inventive concept may be discussed in the exemplary context of an 802.xx implementation (e.g., 802.11a, 802.11g, 802.11 HT, 802.16, etc.), the claims are not so limited. Indeed, embodiments of the present invention may well be implemented as part of any wired and/or wireless system Examples may include embodiments comprising elements of an IEEE 802.3 standard, an IEEE 802.3AE standard, an IEEE 1596 standard, a VITA 26-199x specification, an InfiniBand Architecture Release 1.1 specification, a Quadrics QsNet/QsNet II description, and/or those using multi-carrier wireless communication channels (e.g., orthogonal frequency-division multiplexing (OFDM), discrete multi-tone modulation (DMT), etc.), such as may be used within, without limitation, a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and the like communication systems.

Implementing the apparatus, systems, and methods disclosed herein may improve the ability of various systems to process event notifications related to a variety of fabrics. In addition, the use of fabric-specific implementations may be reduced.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An apparatus, including:
a message passing interface module to receive data from an operating system wait proxy agent included in a direct access provider library to be coupled to a plurality of fabrics

2. The apparatus of claim 1, wherein the direct access provider library further includes:
a plurality of consumer notification modules coupled to the operating system wait proxy agent.

3. The apparatus of claim 1, wherein the direct access provider library further includes:
a plurality of event dispatching modules coupled to at least one consumer notification module coupled to the operating system wait proxy agent.

4. The apparatus of claim 1, further including:
a first memory included in a first one of the plurality of fabrics and coupled to a first interface adaptor included in the direct access provider library to communicate with the message passing interface module coupled to a processor.

5. The apparatus of claim 4, further including:
a second memory included in a second one of the plurality of fabrics and coupled to a second interface adapter included in the direct access provider library to communicate with the message passing interface coupled to the processor.

6. An apparatus, including:
an operating system wait proxy agent module included in a direct access provider library to couple to a message passing interface module, wherein the operating system wait proxy agent module is to receive data from a plurality of fabrics to be coupled to the direct access provider library.

7. The apparatus of claim 6, wherein the direct access provider library further includes:
a plurality of consumer notification modules coupled to the operating system wait proxy agent.

8. The apparatus of claim 7, wherein all notifications provided by the plurality of consumer notification modules are communicated to the operating system wait proxy agent.

9. The apparatus of claim 6, wherein one of the plurality of fabrics includes a network, and wherein another one of the plurality of fabrics includes a memory coupled to a processor capable of communicating with the message passing interface module.

10. A system, including:
a message passing interface module to receive data from an operating system wait proxy agent included in a direct access provider library to be coupled to a plurality of fabrics.

11. The system of claim 10, wherein the plurality of fabrics includes a network.

12. The system of claim 11, further including:
an omnidirectional antenna to receive the data from the network included in the plurality of fabrics.

13. The system of claim 12, wherein the data is formatted according to one of an Institute of Electrical and Electronics Engineers 802.11 standard, an Institute of Electrical and Electronics Engineers 802.16 standard, and an Institute of Electrical and Electronics Engineers 802.20 standard.

14. The system of claim 12, wherein the omnidirectional antenna is included in a multiple-input, multiple-output communications system.

15. The system of claim 12, wherein the direct access provider library further includes:
an interface adaptor coupled to the omnidirectional antenna.

16. The system of claim 10, wherein the data is formatted according to one of an Institute of Electrical and Electronics Engineers 802.3 standard, an Institute of Electrical and Electronics Engineers 802.3AE standard, an Institute of Electrical and Electronics Engineers 1596 standard, a VITA 26-199x specification, an InfiniBand Architecture Release 1.1 specification, a Quadrics QsNet description, and a Quadrics QsNet II description.

17. The system of claim 10, wherein the direct access provider library further includes:
the operating system wait proxy agent; and
a plurality of consumer notification modules coupled to the operating system wait proxy agent.

18. A method, including:
receiving an event notification at a message passing interface from one of a plurality of consumer notification modules coupled to an operating system wait proxy agent after the operating system wait proxy agent is activated by the one of the plurality of consumer notification modules included in a direct access provider library to be coupled to a plurality of fabrics.

19. The method of claim 18, further including:
polling the one of the plurality of consumer notification modules to retrieve the event notification.

20. The method of claim 18, further including:
triggering the one of the plurality of consumer notification modules to provide the event notification by receiving an indication of an event associated with the event notification from one of a plurality of event dispatcher modules.

21. The method of claim 18, further including:
waiting, by the operating system wait proxy agent, for the event notification to be provided by the one of the plurality of consumer notification modules.

22. The method of claim 18, further including:
sending, by the operating system wait proxy agent, the event notification to the message passing interface.

23. An article comprising a machine-accessible medium having associated information, wherein the information, when accessed, results in a machine performing:
receiving an event notification at a message passing interface from one of a plurality of consumer notification modules coupled to an operating system wait proxy agent after the operating system wait proxy agent is activated by the one of the plurality of consumer notification modules included in a direct access provider library to be coupled to a plurality of fabrics.

24. The article of claim 23, wherein the information, when accessed, results in the machine performing:
receiving data at an interface adapter included in the direct access provider library from one of the plurality of fabrics, wherein the data is formatted according to one of an Institute of Electrical and Electronics Engineers 802.11 standard and an Institute of Electrical and Electronics Engineers 802.16 standard.

25. The article of claim 23, wherein the information, when accessed, results in the machine performing:
receiving a multiplicity of event notifications including the event notification at the operating system wait proxy agent from the plurality of consumer notification modules.

26. The article of claim 23, wherein the plurality of fabrics does not include a microprocessor bus.

27. The article of claim 23, wherein the information, when accessed, results in the machine performing:
generating an event at an interface adaptor included in the direct access provider library;
providing an indication of the event to the one of the plurality of consumer notification modules by an event dispatcher module; and
activating the operating system wait proxy agent by the one of the plurality of consumer notification modules responsive to the indication.
